(19) United States
(12) Patent Application Publication
(10) Pub. No.: US 2007/0223762 A1
(43) Pub. Date: Sep. 27, 2007

(54) External sound outputting device

(75) Inventors: Oh Suk Kwon, Seoul (KR); Jong Woo Kim, Seoul (KR); Tae Young Na, Suwon-si (KR); Kyoung Seok Choi, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/712,521

(22) Filed: Mar. 1, 2007

(30) Foreign Application Priority Data
Mar. 2, 2006 (KR) 10-2006-0019982

(51) Int. Cl. H04R 1/02; H04R 9/06

(52) U.S. Cl. 381/334; 381/336

(57) ABSTRACT

An external sound outputting device is provided. The external sound outputting device includes a connection connector and a speaker unit. The connection connector is inserted into a connection terminal of a portable terminal. The speaker unit outputs an electric signal delivered through the connection connector as an audio signal. The speaker unit rotates in multi-directions when the connection connector is connected to the portable terminal.

### BACKGROUND OF THE INVENTION

1. Field of the Invention

The present invention relates to an external sound outputting device, and more particularly, to an external sound outputting device capable of adjusting a sound direction of a speaker to achieve a desirable sound effect.

2. Description of the Related Art

Generally, a speaker is electrical equipment that generates sound by using speaker vibration after converting an electric signal into a sound signal. As more mobile devices are being produced, portable external sound outputting devices for user convenience are actively being developed.

FIG. 1 is a perspective view of a related external sound outputting device.

Referring to FIG. 1, a related external sound outputting device 5 includes a speaker unit 1 for outputting sound, a baffle 4 for protecting the speaker unit 1, a wire 2 connected to the baffle 4, and a connection jack 3 connected to the end of the wire 2.

More specifically, the wire 2 has a predetermined length. The connection jack 3 connected to the end of the wire 2 is typically connected to an output terminal of an audio device. The wire 2 is connected to the speaker unit 1 through the baffle 4. Accordingly, a sound signal is delivered into the speaker unit 1 from the output terminal of the audio device and is outputted toward the front of the speaker unit 1.

Here, it is inconvenient for a user to carry a conventional external sound outputting device. When connected to an audio device through a wire, the conventional external sound outputting device cannot closely contact the audio device due to the wire. Therefore, it is very hard to achieve unity between the conventional external sound outputting device and the audio device.

Moreover, when listening to music by connecting the audio device and the conventional external sound outputting device, there is a limitation in changing the direction of sound from a speaker. Accordingly, it is hard to achieve high-quality stereo sound according to a user's taste or intention.

Moreover, since a portable device has a relatively low-power amplifier, sound outputted through the external sound outputting device is not sufficiently loud and clear.

### SUMMARY OF THE INVENTION

Accordingly, the present invention is directed to an external sound outputting device that substantially obviates one or more problems due to limitations and disadvantages of the related art.

An object of the present invention is to provide an external sound outputting device capable of freely adjusting an angle of a speaker unit.

Another object of the present invention is to provide an external sound outputting device capable of freely adjusting a sound direction from a speaker to obtain a desirable sound field.

A further object of the present invention is to provide an external sound outputting device capable of amplifying a level of outputted sound to achieve a high quality sound effect when being connected to a portable device.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an external sound outputting device including: a connection connector inserted into a connection terminal of a portable terminal; and a speaker unit outputting an electric signal delivered through the connection connector as an audio signal. The speaker unit rotates in multi-directions when the connection connector is connected to the portable terminal.

In another aspect of the present invention, there is provided an external sound outputting device including: a connection connector inserted into an earphone jack of a portable terminal; a baffle for protecting the speaker unit; an enclosure connected to the baffle for rotation and including the connection connector protruding at one side thereof; and a connection unit connecting the baffle to the enclosure for rotation.

According to an external sound outputting device, the speaker unit can rotate in a desirable direction such that an optimized sound quality can be obtained according to a user's taste or music characteristics.

Moreover, since it is connected to a portable mobile device through a socket or a jack, an external sound outputting device is integrated into the portable mobile device as one body. Therefore, a user can easily carry it around.

Additionally, since the external sound outputting device includes a speaker unit and an auxiliary power supplying unit formed as one body, a sound from a mobile phone or a portable device can be amplified to obtain high quality sound.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a related external sound outputting device;

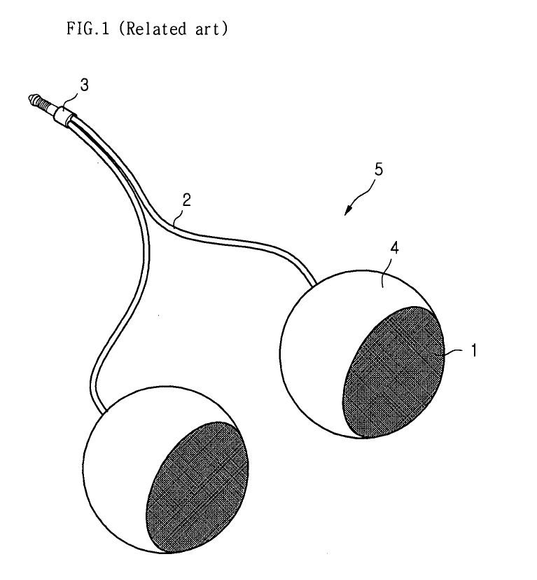

FIG. 2 is a perspective view of an external sound outputting device according to a first embodiment of the present invention;

FIG. 3 is an exploded perspective view of an external sound outputting device according to a first embodiment of the present invention;

FIG. 4 is a sectional view taken along line I-I′ of FIG. 2;

FIG. 5 is a sectional view taken along line II-II′ of FIG. 4;

FIG. 6 is a perspective view of an external sound outputting device according to a second embodiment of the present invention;

FIG. 7 is a perspective view of when an external sound outputting device is mounted on a portable device;

FIG. 8 is a perspective view of when an external sound outputting device of a third embodiment is mounted on a portable device; and

FIG. 9 is a block diagram of an internal system of a portable device having an external speaker according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Moreover, an enclosure of the present invention may be named as a supporting member. A central axis including undulation and protrusion may be named as a connection member.

Hereinafter, an operating principle and a structure of a portable speaker will be described with reference to the drawings.

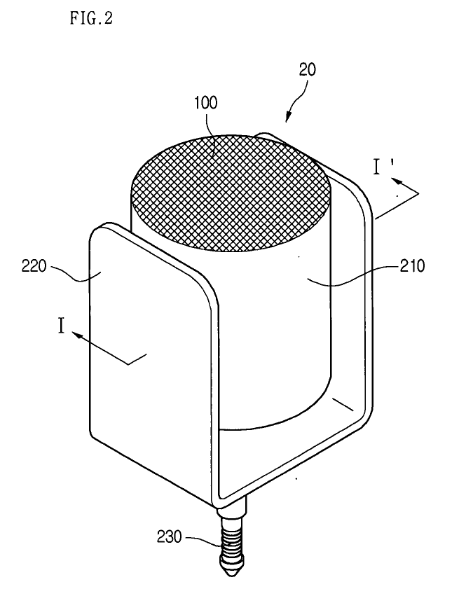

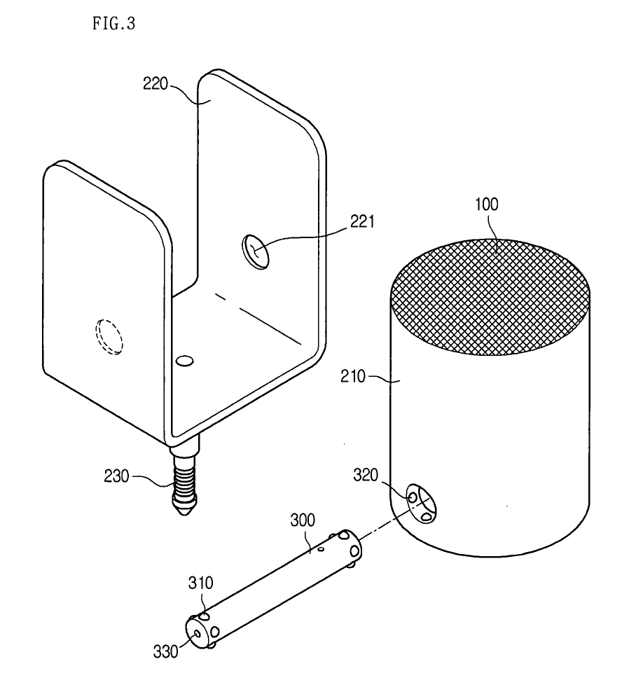

FIG. 2 is a perspective view of an external sound outputting device according to a first embodiment of the present invention. FIG. 3 is an exploded perspective view of an external sound outputting device according to a first embodiment of the present invention.

Referring to FIGS. 2 and 3, an external sound outputting device 20 includes a speaker unit 100 for outputting a sound, a baffle 210 for surrounding and protecting the speaker unit 100, an enclosure 220 for rotating the baffle 210, and a connection connector 230 for being connected to terminals such as mobile phones and PDAs to output sound through the speaker unit 100.

More specifically, in a jack type device, the connection connector 230 protrudes within a predetermined length, and is inserted into a connection terminal of a portable device. An audio processing unit in the portable device, which will be mentioned later, converts a sound signal into an analog signal, and then delivers the converted analog signal to the speaker unit 100. Then, the delivered analog signal is outputted through the speaker unit 100. The speaker unit 100 is protected by the baffle 210, and the baffle 210 is mounted on the enclosure 220 in order to rotate up to 180°.

Here, the enclosure 220 has a “U” shape, and surrounds a portion of the outer circumference of the speaker unit 100. That is, a portion of the enclosure 330 is opened such that the baffle 210 can rotate in a direction. Accordingly, the speaker unit 100 can change its direction and rotate corresponding to an open direction of the enclosure 220.

Further provided is a rotation axis 300 for allowing the baffle 210 to rotate in the enclosure 220.

More specifically, the rotation axis 300 passes through the baffle 210, and both its ends are fixed at an inner circumference of a receiving groove 221 in the enclosure 220. The receiving groove 221 is formed on the inner circumference of the enclosure 220 to receive the rotation axis 300. Protrusions 310 and 320 are spaced a predetermined space apart from each other on an outer circumference of the rotation axis 300 and an inner circumference of the baffle 210 through which the rotation axis 300 passes, respectively. The protrusions 310 and 320 allow the baffle 210 to rotate within a predetermined angle. This will be described in detail.

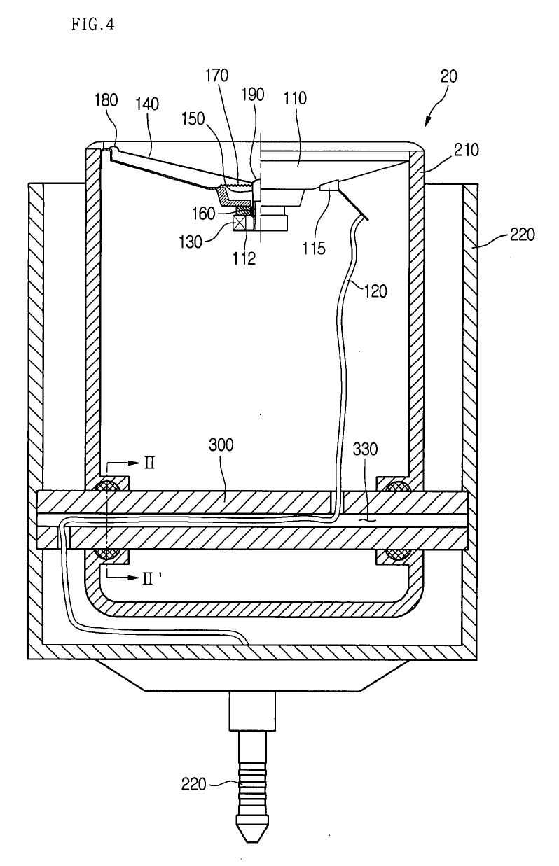

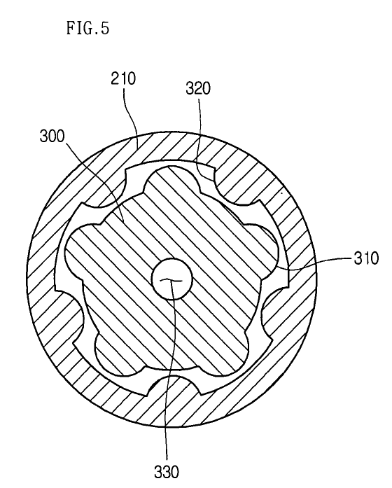

FIG. 4 is a sectional view taken along line I-I′ of FIG. 2. FIG. 5 is a sectional view taken along line II-II′ of FIG. 4.

Referring to FIGS. 4 and 5, the speaker unit 100 of the external sound outputting device 20 includes an external frame 110 fixed at the baffle 210, a yoke 112 extending below the external frame 110, a magnet 130 disposed on one side of the yoke 112, and a bobbin 150 spaced a predetermined distance from the magnet 130.

Moreover, the speaker unit 100 includes a dust cap 190 disposed on the bobbin 150, a voice coil 160 coiled on an outer circumference of the bobbin 150, a vibrating plate 140 disposed on the front of the external frame 110, an edge unit 180 put around an outer edge of the vibrating plate 140, and a damper 170 disposed between the external frame 110 and the vibrating plate 140.

More specifically, the edge unit 180 limits a vibrating range of the vibrating plate 140. The dust cap 190 disposed in the center of the vibrating plate 140 prevents foreign substance from collecting in the speaker unit 100.

Additionally, the voice coil 160 is coiled around the bobbin 150 to form a magnetic circuit in the magnet 130, the yoke 112, and the voice coil 160. The bobbin 150 vibrates the vibrating plate 140 according to Fleming's left hand rule, which is based on a direction of an applied current and the magnetic field of the magnet 130. Additionally, the damper 170 is connected to the bobbin 150 for supporting the vibrating plate 140 and controlling the vibrating range of the vibrating plate 140 at the same time.

Additionally, a wire 120 is connected to a terminal 115 disposed on one side of the vibrating plate 140 to deliver a current having an electric voice signal into the voice coil 160. When the current flows in the voice coil 160, the bobbin vibrates up and down to output sound according to Fleming's left hand rule. Likewise, when the vibrating plate 140 connected to the bobbin 150 moves upward, a positive sound pressure occurs, and when the vibrating plate 140 moves downward, a negative sound pressure occurs. Therefore, the sound wave is outputted toward the front of the enclosure. The sound wave is within the range of 20 Hz to 20 Hz that is audible to humans.

On the other hand, the rotation axis 300 penetrates the baffle 210 in a horizontal direction. Specifically, the baffle 210 can rotate within a predetermined angle with respect to the center of the rotation axis 300.

An angle controlling unit for allowing the baffle 210 to be mounted on the enclosure 220 for rotation will be described in one embodiment. This mounting structure may vary according to various methods.

Specifically, a through hole is formed at a certain point of the baffle 210 such that the rotation axis 300 passes therethrough. A portion where the through-hole is formed is bent toward the inside with a predetermined length. The protrusions 320 are spaced a predetermined distance apart from each other on the inner circumference of the bent portion. The protrusions 310 having the same structure are formed on the outer circumferences of both ends of the rotation axis 300. The protrusions 310 on the outer circumference of the rotation axis 300 engage with the protrusions 320 on the bent portion of the baffles 210. The protrusions 310 and 320 are spaced a predetermined distance apart from each other to rotate step by step by a predetermined angle. For example, when the protrusions 310 and 320 are each formed at 15°, they rotate by 15°. A thin iron plate having a strap shape and a predetermined elastic force is coiled around the rotation axis 300, and protrudes at a predetermined interval to form the protrusions 310 and 330. Alternately, the protrusions 310 and 330 may be bearings. According to the above structure, when the baffle 310 rotates by a predetermined angle, a clicking sound is made.

Moreover, a long hole 330 is formed to allow the wire 120 to penetrate, and the wire 120 is not affected from the rotation of the baffle 210.

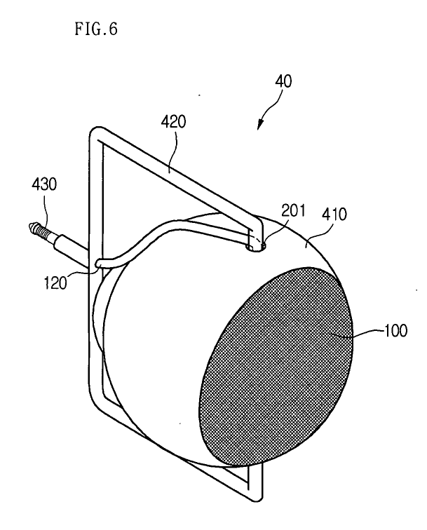

FIG. 6 is a perspective view of an external sound outputting device according to a second embodiment of the present invention.

Referring to FIG. 6, in an external sound outputting device 40 of the second embodiment, the structures of a speaker unit 100, a baffle 410, and a connection connector 430 are identical to those of the first embodiment except for the shape of the supporting member. That is, a “U” shape supporting member 410 is applied instead of the enclosure 220 of the first embodiment. A hinge 201 is formed at the end of the supporting member 410. The wire 120 is passed through the hinge to connect to the terminal 115 of the speaker unit 100.

Here, the supporting member 410 may be mounted to allow the baffle 210 to rotate by using various methods, which is a component of the present invention.

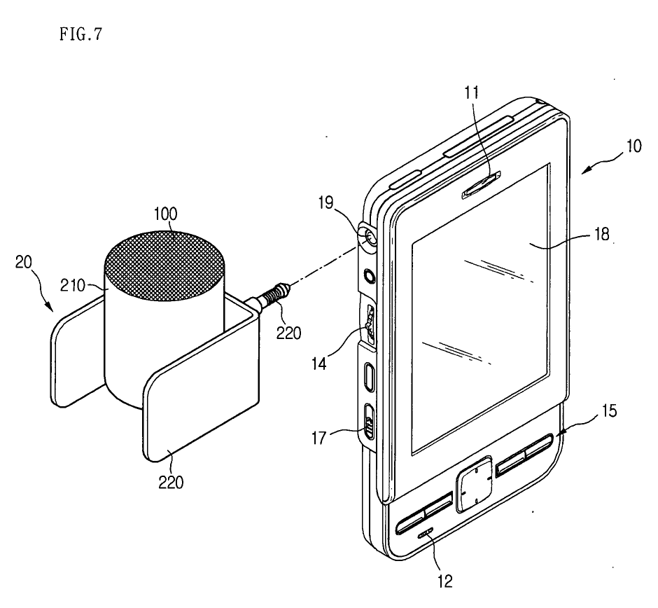

FIG. 7 is a perspective view of when an external sound outputting device is mounted on a portable device.

Referring to FIG. 7, a portable terminal 10 includes a display unit 18 on the front of the portable terminal 10 to display various functions, playing information, etc., and a plurality of key input units 15 in the front lower portion of the portable terminal 10. The key input units 15 include a play button, buttons for adjusting play and search speeds, a stop button, and a pause button. If the portable terminal 10 is a mobile phone, an internal speaker 11 is mounted on the front, and a mike 12 is mounted on the front bottom. An output terminal 19 is provided on the side of the portable terminal 10 for inserting the connection connector 230. More specifically, the output terminal 19 includes an earphone jack for inserting an earphone. Examples of the portable terminal 10 are mobile phones, PDAs, PMPs, and MP3s.

Hereinafter, a process of mounting an external sound outputting device 20 into the portable terminal 10 will be briefly described.

First, a user turns on the portable terminal 10. The external sound outputting device 20 is mounted on the output terminal 19 of the portable terminal 10. Here, the user inserts the connection connector 230 of the external sound outputting device 20 into the output terminal 19. Next, the user rotates the speaker unit 100 of the external sound outputting device 20 by a predetermined angle to a desirable direction. More specifically, the external sound outputting device 20 may rotate 360° by using the connection contactor 230 as an axis for rotation, and also may rotate 180° by using the rotation axis 300. That is, the axis for rotation of the connection connector 230 and the central axis of the rotation axis 300 are perpendicular such that a sound direction of the external sound outputting device 20 can be easily adjusted.

Additionally, the connection connector 230 of the external sound outputting device 20 may be the jack type or an interface such a USB port according a terminal type of the portable terminal 10. A structure using another interface will be described in more detail with reference to the drawings.

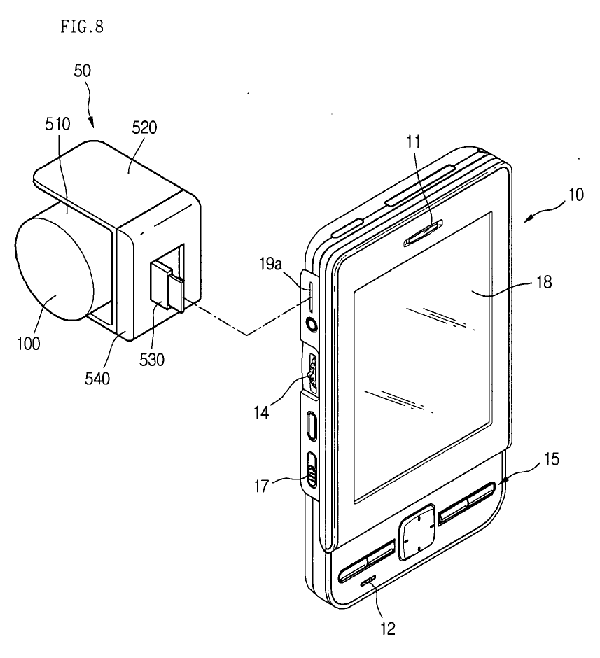

FIG. 8 is a perspective view of when an external sound outputting device of a third embodiment is mounted on a portable device.

Referring to FIG. 8, an external sound outputting device 50 of the third embodiment includes a speaker unit 100, a baffle 510 for protecting the speaker unit 100, an enclosure 520 for allowing the baffle 510 to rotate, an auxiliary power supplying unit 540 disposed on one side of the enclosure 520, and a connection connector 530 disposed on one side of the auxiliary power supplying unit 540.

Additionally, an earphone jack 19a is formed on one side of the portable terminal 10 to insert the connection connector 530.

More specifically, the auxiliary power supplying unit 540 supplies a current for increasing sound output from the speaker unit 100 when the external sound outputting device 50 is connected to the portable terminal 10. Since the auxiliary power supplying unit 540 and the speaker unit 100 are provided in one body, a low-powered output sound from the portable terminal 10 increases up to a level identical to that of a conventional high-power audio system.

Here, the connection connector 540 includes a pin for supplying a current and a pin for transmitting an audio signal, and also requires at least two pins for supplying a current and three pins for providing stereo sound. It is apparent that a conventional 10 pins or 24 pins connector can be used. Moreover, the connection connector 540 may be provided with a separated connector for supplying a current and a separated connector for receiving a sound signal. That is, two jacks may be provided on the side of the portable terminal 10, and two jacks protrude at one side of the external sound outputting device. Thus, the two jacks can be inserted simultaneously. A rotation axis (not shown) is connected to the rear of the connection connector 540 such that the integrated enclosure 520 and auxiliary power supplying unit 540 can rotate when being mounted on the portable terminal 10.

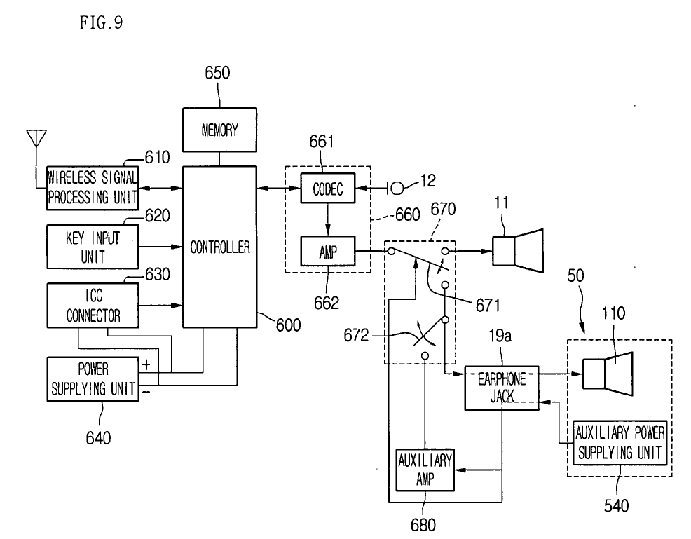

FIG. 9 is a block diagram of an internal system of a portable device having an external speaker of the present invention.

Referring to FIG. 9, a portable terminal 10 having an external speaker includes a controller 600, a wireless signal processing unit 610 for transmitting and receiving a wireless frequency signal, a key input unit 620 provided in the portable terminal 10, an ICC connector 630 connected to a charging device for charging a power supplying unit 640 that is connected to a power terminal of the portable terminal 10, a memory 650, and an audio processing unit 660.

More specifically, the charging device is connected to the ICC connector 630 to store a charging current in the power supplying unit 640.

Moreover, the audio processing unit 660 includes a CODEC 661 and an amp 662.

More specifically, the CODEC 661 converts PCM data provided from the controller 600 into an analog voice signal for outputting through the internal speaker 11 or the external sound outputting devices 20, 40, and 50. Additionally, the CODEC 661 converts a voice signal from the mike 12 into PCM data to provide the PCM data into the controller 301. The amp 662 amplifies the voice signal from the CODEC 661 to output a desirable sound.

Moreover, a switching unit 670 is provided on output terminal of the amp 662 to determine whether the voice signal is outputted through the internal speaker 11 or the external sound outputting device. An earphone jack 19a into which the connection connector of the external sound outputting device is inserted is connected to an auxiliary amp 680.

More specifically, the switching unit 670 includes a first switch 671 and a second switch 672. The first switch 671 selectively connects the internal speaker 11 and the amp 662, and the second switch 672 selectively connects the auxiliary amp 680 and the earphone jack 19a. The controller 600 detects whether the external sound outputting device is inserted or not, and then controls an operation of the switching unit 670.

More specifically, when the external sound outputting device is not inserted, the first switch 671 operates to connect the amp 662 and the internal speaker 11. The voice signal outputted from the amp 662 is outputted through the internal speaker 11.

On the other hand, when the external sound outputting device is inserted, the second switch 671 operates to connect the amp 662 and the earphone jack 19a. According to the sound outputting devices 20 and 40 of the first or second embodiment, when the external speaker without the auxiliary power supplying unit 540 is inserted into the earphone jack 19a, the second switch is turned off. Accordingly, the voice signal outputted from the amp 662 is outputted into the speaker unit 100 through the connection connector that is inserted into the earphone jack 19a. However, when the external sound outputting device of the third embodiment is inserted into the earphone jack 19a, the first switch 671 is disconnected from the internal speaker 11, and is connected to the earphone jack 19a. The second switch 672 is turned on to connect the auxiliary amp 680 and the earphone jack 19a. Accordingly, the voice signal outputted from the amp 662 is amplified one more time by the auxiliary amp 680, and is outputted into the speaker unit 100. Moreover, the current charged in the auxiliary power supplying unit 540 is supplied into the auxiliary amp 680 through the earphone jack 19a.

Here, the auxiliary amp 680 is integrated into the external sound outputting device 50 such that it can be applied to all types of conventional portable terminals 10. That is, when the external sound outputting device 50 including the auxiliary power supplying unit 540 and the auxiliary amp 680 are combined with the portable terminal 10, power is applied from the auxiliary power supplying unit 540 into the auxiliary amp 680, and then the second switch is turned on. Then, regardless of the type of portable terminal 10, a low-powered output from the CODEC 661 and the amp 662 are amplified into a high-powered output such that high quality sound can be provided.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An external sound outputting device comprising:
a connection connector inserted into a connection terminal of a portable terminal; and
a speaker unit outputting an electric signal delivered through the connection connector as an audio signal,
wherein the speaker unit rotates in multi-directions when the connection connector is connected to the portable terminal.

2. The external sound outputting device according to claim 1, further comprising:
a baffle receiving the speaker unit;
a supporting unit connected to the baffle for rotation;
a rotation axis allowing the baffle to be connected to the supporting unit for rotation; and
an angle controlling unit allowing the baffle to rotate step by step by a predetermined angle.

3. The external sound outputting device according to claim 2, wherein the angle controlling unit comprises bearings on an outer circumference of the rotation axis and one side of the baffle through which the rotation axis passes.

4. The external sound outputting device according to claim 2, wherein the angle controlling unit comprises:
a metal plate surrounding the outer circumference of the rotation axis, and including a plurality of protrusions with a predetermined elastic force; and
a plurality of protrusions disposed on the baffle and engaging with the protrusions of the metal plate.

5. The external sound outputting device according to claim 2, wherein the baffle rotates 180° in a direction perpendicular to the rotation axis of the connection connector.

6. The external sound outputting device according to claim 2, further comprising:
an auxiliary power supplying unit provided to the supporting unit as one body and increasing a sound output from the speaker unit; and
an auxiliary amp receiving a current from the auxiliary power supplying unit, for amplifying a sound signal.

7. The external sound outputting device according to claim 6, wherein the auxiliary amp is provided to the auxiliary power supplying unit as one body.

8. An external sound outputting device comprising:
a connection connector inserted into an earphone jack of a portable terminal;
a baffle for protecting the speaker unit;
an enclosure connected to the baffle for rotation and including the connection connector protruding at one side thereof; and
a connection unit connecting the baffle to the enclosure for rotation.

9. The external sound outputting device according to claim 8, wherein the connection unit is a rotation axis passing through the baffle and including both ends fixed at an inner circumference of the enclosure.

10. The external sound outputting device according to claim 9, further comprising a plurality of bearings or protrusions having a predetermined electric force on an outer circumference of the rotation axis and a surface of the baffle through which the rotation axis passes, for allowing the baffle to rotate in multi-directions.

11. The external sound outputting device according to claim 8, further comprising an auxiliary power supplying unit provided to the enclosure as one body, and providing a current to increase a sound output.

12. The external sound outputting device according to claim 11, further comprising an auxiliary amp receiving the current from the auxiliary power supplying unit, for amplifying a voice signal.

13. The external sound outputting device according to claim 8, wherein the connection connector comprises a connector for delivering a sound signal and a connector for supplying power in one body or separately.

14. The external sound outputting device according to claim 8, wherein the baffle rotates two-dimensionally when connected to the portable terminal.
